(19) United States
(12) Patent Application Publication
(10) Pub. No.: US 2013/0035958 A1
(43) Pub. Date: Feb. 7, 2013

(54) KEYSTROKE CODED TEMPLATE FOR CREATING MEDICAL RECORDS

(71) Applicant: David A. O'Keeffe, Orchard Park, NY (US)

(72) Inventor: David A. O'Keeffe, Orchard Park, NY (US)

(21) Appl. No.: 13/564,239

(22) Filed: Aug. 1, 2012

Related U.S. Application Data
(60) Provisional application No. 61/514,090, filed on Aug. 2, 2011.

(51) Int. Cl. G06Q 50/24

(52) U.S. Cl. 705/3

(57) ABSTRACT

Disclosed is a medical record keeping system that includes a computer that operates a medical record software for maintaining patient records. The system may be operated in the following manner: (1) inputting an initial keystroke set that corresponds to the group consisting essentially of a symptom or negative review of systems, exam entries, or visit entries, (2) inputting a second keystroke set after the first keystroke set, the second keystroke set corresponds to a particular organ system or anatomical part, (3) inputting in a third keystroke set after the second keystroke set that pertains to a condition or medical observation. The steps of first typing, second typing, and third typing define the reference code, wherein the reference code results in the display of said at least one phrase.

### RELATED APPLICATION

This application claims the benefit of U.S. Provisional Application No. 61/514,090, filed on Aug. 2, 2011. The entire teachings of the above application are incorporated herein by reference.

### BACKGROUND OF THE INVENTION

A medical chart or medical record is a systematic documentation of a patient's medical history and care. The term ‘Medical Chart’ is used both for the physical folder for each individual patient and for the body of information which comprises the total of each patient's health history.

The information contained in the medical record allows health care providers to provide continuity of care to individual patients. The medical record also serves as a basis for planning patient care, documenting communication between the health care provider and any other health professional contributing to the patient's care, assisting in protecting the legal interest of the patient and the health care providers responsible for the patient's care, and documenting the care and services provided to the patient. In addition, the medical record may serve as a document to educate medical students/resident physicians, to provide data for internal hospital auditing and quality assurance, and to provide data for medical research. Personal health records combine many of the above features with portability, thus allowing a patient to share medical records across providers and health care systems.

Because of the need for careful and systematic diagnosis, doctors are trained from the earliest classes of medical school to follow a systematic approach to diagnosis called the “SOAP” system. SOAP is an acronym for Subjective, Objective, Assessment and Plan. “Subjective” is a term that refers to the health professional's first encounter with data regarding a patient's medical condition. The health care professional hears a subjective description of the patient's condition as described by the patient. The assessment is subjective because the information about the information about the condition is based upon the patient's interpretation of his/her physical condition. For example, one patient may describe their condition as a high fever, dizziness or level of pain. However, one patient's interpretation of a high fever, or level of pain may differ from another's depending upon their experience, pain threshold. However subjective, the information is still an important consideration by the doctor.

The term “objective” refers to direct observations by the professional of the patient's conditions including measurable, scaled observations. Such objective factors may include the sound of the patient's inhalation or exhalation, heart rate, blood pressure, body weight, temperature, physical appearance of systems, organs and body parts. The information is objective because it is based upon direct observations of the health care professional that is trained in observation and objectivity.

The term “Assessment” means the diagnosis or preliminary assessment of a patient's condition. It may include an assessment that the patient may suffer from a number of potential symptoms that require further diagnosis, exploration or input. Optionally, it may be a single conclusion of one or more conditions.

The term “Plan” refers to a formulation of the plan a health care professional makes based upon the professional's previous Assessment. The plan may include one or more of (1) additional tests or information gathering including (i)blood or fluid analysis (ii) radiological examination (iii) psychological evaluation (iv) exploratory surgery, or other diagnostic information gathering that may be relevant to rule out or diagnose one or more conditions. The plan may be a treatment plan that includes, patient health care instructions, pharmaceutical treatment, involvement of other health care professionals, such as a physical therapist, social worker or occupational therapist. The plan may require follow-up visits or leave additional visits to the discretion of the patient.

The order of the SOAP process is as important as the steps themselves. The subjective information of the patient determines the nature of the objective examination by the health care professional. The subjective and objective leads to the assessment or diagnosis. The plan is based upon the diagnosis. It is therefore desirable for a medical charting system, including an automated or computerized medical charting system to take advantage of the SOAP system.

Because of its importance to the long-term health and well being of a patient, medical records require considerable detail and accuracy. Some of the medical charting must be personally completed by a physician who's time demands are considerable. Thus, there is a continual need to develop technology that will permit a physician and its staff to be more efficient at medical charting without compromising accuracy and completeness.

To improve the efficiency of charting, electronic charting systems have been developed. However, some challenges exist that make medical charting difficult for physicians to adapt. Often, physicians have unreliable computer skill sets and have never acquired typing skills sufficient to make electronic charting systems feasible. Moreover, due to the time constraints on physicians, it is often difficult and costly for physicians to acquire an new skill set. The lack of skill set in physicians often result in disruption of patient interaction as the physician attempts to muddle through the electronic charting system. If the charting system electronic or otherwise does not logically follow the doctor patient routine, the charting program can be distracting for the physician which could result in a less than thorough examination or disruption of the attorney.

SpringCharts™ is a commercially available charting system. It can be a stand alone system or integrated into a more comprehensive electronic medical record charting system. The program utilizes a series of drop down menus and fill-in screens to complete medical charting. See http://www.medicaleharting.comlemr-software/electronic-medical-record-software-index.htm.

MediNotes™ is another charting system that can be used as a stand alone system or synchronized into an existing electronic medical reporting system. MediNotes™ features flexible note templates that allow you to customize the program to suit the clinical and business needs of the physician and physician's staff With the ability to create common lists for frequent exams, medications and symptoms, MediNotes™ enables the user to easily document multiple chief complaints using color—coded text that guides you though each patient encounter. MediNotes™ does not use smart text to reference commonly used phrases and clusters. See http://www.medinotes.com/productslmne-emr.php.

Doc U Chart™ is an electronic medical record for a tablet PC so that digital notes can be taken during exam. The charting is manually done, but digitally captured. Therefore, there is no use of smart text to reference charting templates, phrases and clusters. See http://www.docuchart.com/electronic_charting.asp.

American Medical's software comprises a series of drop down menus and various charting screens. See http://www.americanmedical.com.

A drop down menu system may be faster than manual charting, there is still a need for a system that could further improve the efficiency of medical charting in a systematic way that reduces physician typing time, follows the SOAP system, suggests objective indicia based upon subjective information, provides assessment suggestions based upon the objective and subjective, and provides plan suggestions based upon the subjective and objective information as well as the decided assessment. It is further advantageous to have a system that flows with rather than distracts from the physician patient interaction and improves accuracy. It is further advantageous to have a system that is efficient enough that the subjective and objective can be efficiently recorded with minimal keystrokes or computer steps by the physician. The present invention satisfies these and other needs.

### SUMMARY OF THE INVENTION

Embodiments of the present invention have several advantages over prior medical charting software approaches, including improving typing efficiency by requiring only a few keystrokes to reference large amounts of data in the form of phrases, clusters of phrases and templates.

Phrases, clusters of phrases or templates are accessible by reference codes that contain at least three keystroke sets of one or more keys each. The system is organized in a way that the physician or medical professional using the charting system can easily learn the simple codes to access large amounts of typed information by a few keystrokes. A library of phrases or clusters of phrases exists. They are first organized into several groups. Groups relating to the present invention included a symptom group of phrases and clusters of phrases relating to positively observed symptoms. A negative review of systems group of phrases and clusters of phrases relating to symptoms that the patient does not experience. An objective group of phrases and clusters of phrases pertains to medical examination observations that are objectively observed and measured in an examination by a healthcare professional. A diagnosis group of phrases and clusters of phrases pertain to diagnostic conclusion. A plan group of phrases and clusters of phrases pertain to diagnostic plans. Subsets of one or more of these groups are organized by the organ system or by specific anatomical parts.

A specific desired phrase can be inserted by typing in a first keystroke set to identify a first keystroke group. The second keystroke set identifies a particular organ system or anatomical part. The third keystroke set identifies a medical fact relevant to the organ system or anatomical fact and calls up a group of phrases or clusters of phrases.

Additionally, a smart text system can be employed, so that a number of possible reference codes options will display based upon the text already inserted into the reference code. For example, the smart text system means that after the first and second keystroke sets have been inserted a number of options appear that give the user of completing the reference code by typing additional letters to narrow the reference code options or allowing the user to select possible options from a list of smartphrases.

By sequentially typing a reference code of three sets of keystrokes, whole paragraphs and clusters of paragraphs of relevant charting text can be accessed. By sets of keystrokes it is meant one two or more keystrokes that represent a concept that when combined with other sets of keystrokes narrow the physicians choices to one or more corresponding phrases, clusters of phrases or templates. The first keystroke set represents a general charting function. The second keystroke set generally represents an organ system, anatomic part or other logical narrowing identifier such as male, female, adult, child, or geriatric. The third keystroke set represents a particular medical fact including a medical condition, observation, conclusion or recommendation. The present invention provides a complete set of phrases or clusters of phrases that can be stored in a medical charting program and used to enhance an existing medical charting program.

In one embodiment, the order of the keystroke sequence follows generally the SOAP system. First, subjective fact are recorded based upon a patient's subjective interpretation of bodily symptoms. This includes negative review of systems and negative symptoms. Objective data is then entered. Diagnosis based on medical analysis is next recorded. Finally, treatment plan is inserted. The charting system has the advantage that the entry or review of subjective provides an informal checklist or guide for medical examination. Optionally, the phrases or clusters of phrases relating to a particular condition can contain a specific list of all symptoms and negative symptoms, examinations required, and treatment plan options and follow-up items. Thus, more thorough examination can result from the present system in addition to more thorough documentation.

The charting system enables a series of three keystroke sets to access clusters of phrases to accommodate complex assessment and diagnosis needs or simple phrases for more basic assessment or diagnosis charting based upon the subjective and objective observations. The charting system is adaptable from simple charting needs to the most complex charting issue. Data can be added and the phrases modified after being called up to ensure that the physician can have 100% control over the content and format of the charting and that the data can be matched to each individual patient for each individual encounter. New charting phrases can be programmed to suit ongoing changing needs of physicians in a user friendly format.

Additionally, and importantly the phrases serve as a reminder or “checklist” during the assessment and plan stages of medical decision making and charting. Therefore, the charting system becomes more than a means of recording but an interactive tool to improve patient assessment, treatment plans, follow up items and documentation. Thus an improvement in speed of charting, quality of diagnosis and completeness of treatment options can be observed by one or more embodiments of the present invention.

### BRIEF DESCRIPTION OF THE DRAWINGS

FIG. 1 is a block, flow diagram representing stages of a patient interaction from telephone call to office visit to treatment plan and follow-up.

### DETAILED DESCRIPTION OF THE INVENTION

The medical charting system can be used with any medical charting programs that are compatible with smart text. In one embodiment, the medical charting system is MyChart Personal Health Record Software, which can be obtained from Epic in Verona, Wis.(http://www.epic.com). Smart text system is available with the MyChart Personal Health Record Software and uses a “.” followed by a code which accesses a phrase. Based upon the sequence of keystrokes, a more complete phrase is automatically inserted. In the present case, the phrases uses a simple, easy to learn set of keystrokes that will call up templates, phrases and clusters of phrases in response to a series of keystrokes. The keystroke sequence has been created by a physician to follow the general approach that physicians follow in medical charting.

By way of example and without limitation, the first keystroke relates to one of a set of categories of data entry. A code letter corresponds to one or more activity categories that prompts access of a series of templates, phrases or clusters of phrases. In one embodiment the letter code relates to one or more of the following: (1) S-recording of symptoms, (2) N-recording a negative review of systems, (3) X-recording examination notes, (4) D-writing a diagnosis, (5) P -outlining a medical plan (6) T-designing a treatment, (7) R-prescribing a medication (i.e., Rx), (8) A-listing a particular part of the anatomy, (9) I -outlining general information or instructions, (10) L-preparing standard correspondence (i.e. letters, faxes and emails, (11) T-recording a telephone consultation or (12) V-notating an office visit.

In some instances, the same letter can refer to two different meaning categories of phrases. For example, T is the initial keystroke to initiate a treatment related phrase, cluster or template and to prompt a phrase, cluster or template to record a telephone call. Confusion is avoided because subsequent keystroke sets for a telephone consultation are defined to be distinct from subsequent keystroke sets for a treatment. Therefore, overlap and ambiguity of codes are avoided despite the similarity of the keystroke sets for different categories.

An examination of the various keystroke sets in the reference code system now follows:

TABLE 1
First Letter Functions is a list of a first set of
keystrokes and their respective functions.
Column 1 represents primary functions of the
keystrokes sets. Column 2 represents additional
possible initial keystrokes relating to different functions.
EXEMPLARY FIRST KEYSTROKE SETS

| LETTER | |
|---|---|
| CODE | MEANING |
| S | SYMPTOMS |
| N | NEGATIVE |
| | REVIEW OF |
| | SYMPTOMS |
| X | EXAMINATION |
| D | DIAGNOSIS |
| P | PLAN |
| T | TREATMENT |
| G | GOAL |
| A | ANATOMY |
| I | INFORMATION OR |
| | INSTRUCTION |
| L | LETTER |
| R | PRESCRIPTION (Rx) |
| T | TELEPHONE CALL |
| V | OFFICE VISIT |

In one embodiment, the first keystroke “S” relates to symptoms, positive symptoms or positive review of systems observations. In another embodiment, the first keystroke, “N”, relates to a negative review of systems or negative “ROS”. “S” and “N” keystrokes generally identify subjective information from the client that refer to positive conditions “S” or lack of conditions, “N.” Alternatively, the first keystroke is “X” and leads to phrases and clusters of phrases relating to objective examinations. The second keystroke for “S”, “N” and “X” categories are largely the same and follow the review of systems logic (largely followed by physicians) or identifies a discrete part of the anatomy. The second keystroke generally follows the review of systems foRmat or identifies discrete parts of the anatomy. Tables 2A and 2B illustrate the second keystroke set for recording symptoms relating to “S”, “N” and “X”. The second set of keystrokes in the reference code serve to narrows the choice of phrases, templates or clusters of phrases dependent in part upon the first letter selected. For example, if the first letter was “A”, corresponding to Anatomy the next keystroke, “C” followed by “W”, will prompt the insertion of “chest wall” or a cluster relating to chest wall. If “F” is selected, there is prompted a phrase, cluster of phrases or template relating to the foot.

TABLE 2A
ORGAN SYSTEM RELATED SECOND KEYSTROKE SETS

| SECOND | |
|---|---|
| KEYSTROKE | MEANING |
| AP | Appearance |
| AL | Allergy |
| CON | Constitutional |
| C | Cardiovascular |
| D | Dermatologic |
| E | Ear, Nose and Throat |
| ENDO | Endocrine |
| G | Gastrointestinal |
| HE | Hematological |
| I | Immunologic |
| LY | Lymphatic |
| M | Musculoskeletal |
| N | Neurological |
| 0 | Ophthalmologic |
| P | Pulmonary |
| RH | Rheumatologic |
| T | Thyroid |
| U | Urologic |
| V | Vitals |
| X | Extremities |

TABLE 2B
ANATOMICAL RELATED SECOND KEYSTROKE SETS

| SECOND | |
|---|---|
| KEYSTROKE | MEANING |
| A | Ankle |
| CS | Cervical Spine |
| CW | Chest Wall |
| E | Ear |
| EL | Elbow |
| F | Foot |
| Fl | Finger |
| H | Head |
| HA | Hand |
| HI | Hip |
| J | Joint |
| K | Knee |
| LL | Lower Leg |
| LS | Lumbar Spine |
| LX | Lower Extremity |
| M | Mouth |
| NE | Neck |
| N | Nose |
| PR | Prostate |
| Q | Quadriceps |
| S | Shoulder |
| ST | Sternum |
| T | Tibia |
| T | Toe |
| TMJ | Temporomandibular Joint |
| UX | Upper Extremity |
| | Wrist |

TABLE 2C
MISCELLANEOUS SECOND KEYSTROKE SETS

| SECOND | |
|---|---|
| KEYSTROKE | MEANING |
| A | Adult |
| B | Basic |
| B | Bilateral |
| C | Course |
| CH | Check |
| DSC | Discussed |
| E | Effectiveness |
| F | Fever |
| F | Follow-up |
| F | Female |
| G | Geriatric |
| G | Goal |
| I | Improved |
| I | Illness |
| I | Increase |
| L | Left |
| M | Male |
| O | Occurrence |
| P | Pain |
| PR | Preventative |
| R | Reviewed |
| RV | |
| S | Severity |
| T | Time |
| U | Upper |

The logical organization of the system of the present invention creates several advantages of efficiency and ease of learning the system of the present invention. The sequence of keystrokes should follow the thought process that a physician follows to approach a particular task. For example, if a physician records a symptom or a negative review of systems (ROS), they would indicate the related keystroke (e.g. S or N). Next, the physician would be prompted to look at the particular system or organ to which the problem relates. Thus, the second or second and third keystroke(s) would pertain to the particular system or anatomical part to which the symptom or negative ROS was related. Systems or anatomical part and corresponding letter codes of one embodiment include but are not limited to A-allergy, A-Ankle, C-cardiovascular, CS-cervical spine, CW-chest wall, D-Dermatologic, E-ear, EL-elbow, F-foot, Fl-Finger, HE-hematologic, HI-hip, HA-Hand, G-gastrointestinal, H-head, I-M-immunologic, J-joint, K-knee, L-lumbar spine, LY-lymphatic, MS-musculoskeletal, N-neurologic, NE-neck, NO-Nose, 0-ophthomologic, P-pulmonary, Q-quadracept, R-rheumatologic, S-shoulder, ST-sternum, T-thyroid, U-urologic, V-vitals, W-wrist, Y-psychiatric. When organizing the keystrokes in this sequential manner, the keystrokes match the sequential thought process that a physician generally follows in a diagnosis. Depending on the particular specialty of the healthcare professional using the system, other anatomical shortcuts may be more convenient than system identifiers. For example, a professional that specializes in ear, nose and throat, may modify the second keystroke set to have more categories that pertain to different anatomical parts relevant to the condition.

However, in some instances, it may be preferable to use optional second keystrokes Tables 2A, 2B and 2C show exemplary second keystroke sets relating to organ systems (Table 2A), anatomical terms (Table 2B) and miscellaneous second keystroke sets (Table 2C). Optionally, it may be desired that the second keystroke identifies relevant demographic or other patient information other than the organ system or body part, age category identifiers, sex identifiers.

A third keystroke set begins to define the actual physical condition whether subjective (patient observed) or objective (observed by the physician during examination). Attached hereto as Appendix A: is a list of smart text keys and their corresponding phrases, clusters of phrases, or templates. They include a first keystroke set, a second keystroke set and a third keystroke set.

The invention eases the task of charting by accessing pertinent phrases that suit the logical context and the details of the particular encounter with the patient. This is achieved by building from commonality and capitalizing on repetition. Automated repetition is an essential strength of the invention. All medical encounters include common aspects and some repetitive tasks.

The particular pattern of phrases is organized around organ systems. Medical knowledge and the functional use of our knowledge are based on organ systems. A charting process that parallels the organ system is easier for a physician to adopt. Use of the invention in one or more embodiments will reduce obstruction to the physician's work habits and patterns, and provide ample opportunity for thorough documentation for coding, diagnostic investigation and research, and most certainly paperwork related to insurance claims, Medicare and Medicaid related claims and audits. Moreover, the individual physician can tailor and embellish the program.

The majority of reference codes that relate to a patient encounter are organized according to the Review of Systems (ROS) approach. Much of diagnosis and charting relates to ruling out negative conditions so a considerable amount of charting time relates to repetition of negative or notional conditions. There are also common positive ROS. These positive ROS are the symptoms of the patient that are specific to ultimate diagnosis. Likewise, there are common pertinent negative examinations and common specific positive examinations required for the ultimate diagnosis. Charting requires documentation of all of this information.

The group of common positive and negative conditions and examinations can be organized into a cluster. A “cluster” is a group of data relevant to a particular diagnosis that can be called up by the use of a smart text reference code and one or more of the information in the cluster may be called up by different smart text reference code. Typically but not always, a cluster relates to more complex patient scenarios. For example, multiple conditions need to be ruled out for a set of recorded symptoms and negative symptoms. Alternately, a single condition diagnosis may have a complex treatment and follow-up plan. The information is organized according to the organ systems and when clustered together makes up the relevant details of the patient's history and examination. A cluster can be accessed by typing multiple reference codes in a single inquiry line so that the health care professional can in a single line access multiple related phrases. Alternatively and optionally, a single access code can be programmed to call up a cluster of phrases preprogrammed in response to a single reference code command.

### EXAMPLE

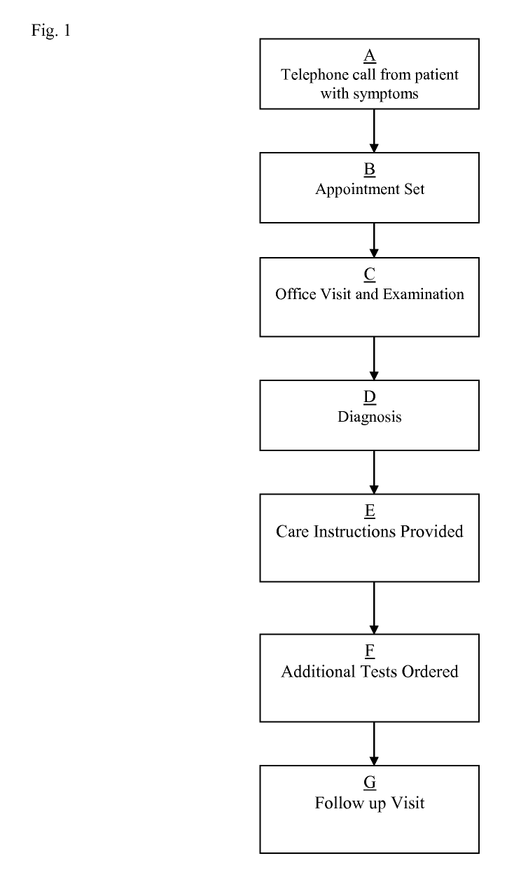

By way of example, the system of one embodiment is exemplified with reference to FIG. 1. A typical patient consultation scenario involving a telephone consultation, an office visit and examination and a follow-up visit is shown in a flow diagram. Charting software is provided by Epic, Wisconsin USA. Although, the present invention is useful with a variety of existing medical charting software packages, without undue experimentation by a person of ordinary skill in the art. The Epic software has smart text capabilities. In one embodiment, the software is accessible by a personal digital assistant or smart phone.

The series of consultations begins with a call from the patient to set an office visit for an upper respiratory infection (URI) is represented in FIG. 1 by box A. The healthcare worker that responds to the call will access the medical file of the patient by name, address, birthdates or other identifying information. Then, the user accesses the appropriate page to enter charting information. Pre-programmed reference codes for telephone consultation begin with “T.” The reference code, “.TEURI” calls up a telephone consultation for an upper respiratory infection. The semantics of one system of the present invention requires a reference code to begin with a “.” (dot or period) followed by the first set of keystrokes. In this case, the reference code begins with “T” which means telephone consultation. Then a second set of keystrokes is represented by “E” for ear, nose and throat system. The third set of keystrokes is “URI” for upper respiratory infection.

The reference code, “TEURI” references a phrase that documents the complaint of the patient. It may, for example, include the text as follows:
Patient called on Sep. 12, 2009 at 10:27 AM complaining of a mild fever (less than 101 Degrees Fahrenheit), malaise, sore throat, head congestion, coughing sputum and runny nose.
Negative Review of Symptoms—Confirmed that none of the following symptoms are present, (1) chest pain or difficulty breathing, (2) coughing sputum combined with fever over 101 Degrees Fahrenheit that lasts longer than two days, (3) history of asthma or cardio pulmonary obstructive disorder (4) coughing blood.
Care Instructions Provided—Patient is instructed to get lots of rest, drink plenty of fluids, take over the counter pain medication for pain relief and monitor. the fever.
Follow-Up: Patient is instructed to follow-up with a call if (2) symptoms significantly worsen, (3) don't improve after one-week (4) patient has chest pain or difficultly breathing (5) discovers blood in sputum.

The above is a cluster relating to a telephone call reference code for an upper respiratory infection. The nurse or healthcare professional answering the phone can use the review of symptoms, negative review of systems to determine whether an immediate appointment needs to be set with the doctor. Simple home care instructions can be provided over the phone. Follow-up instructions can be provided to the patient. The reference code “.TEURI” is a cluster because it contains phrases for upper respiratory infection symptoms and negative review of symptoms, follow-up items, and care instructions that can be accessed individually or in other clusters. The system illustrates an advantage of avoiding error when the healthcare professional has clear guidelines of when to recommend an appointment with the physician and when not to recommend an appointment with a physician.

In our example and as referenced by Box B of FIG. 1, after two additional days of fever over 101 Degrees Fahrenheit and unabated production of sputum, the patient calls again for an appointment with the physician. The person sets the appointment and types in “.AURIF” which accesses a cluster relating to an appointment upper respiratory infection with a fever. The following cluster of phrases is accessed in the medical charting system.
“Patient called at Sep. 16, 2009, at 2:15 PM for an appointment complaining of a fever greater than 101 Degrees Fahrenheit for longer than two days, malaise, sore throat, head congestion, coughing sputum and rumly nose. Patient confirmed that none of the following symptoms are present: (1) chest pain or difficulty breathing, (2) history of asthma or cardio pulmonary obstructive disorder and (3) coughing of blood.

At the appointed time, the patient meets at the doctor's office for a medical examination. This is represented in Box C of Fig. I. The healthcare worker then reviews the symptoms of an Upper Respiratory Infection with the patient using the phrase as a checklist to ensure that charting is complete. If symptoms are not present, they can be deleted from the phrase. The nurse typically sees the patient to initiate the examination. The reference code “.XVBPTWT” may be used to access a series of phrases for recording vital signs. “X” is the initial keystroke set. “V” is the second keystroke set for “vital signs”. Reference code, “.BPTWT” access a cluster of phrases that template the recording of blood pressure, heart rate, temperature, and weight.

The physician examines the patient following the SOAP format. The doctor asks about the subjective symptoms. The charting system matches the SOAP format and has the ability to bring the details more efficiently, than previously, build upon the organs system and the structure of the charting. The translation to the text proceeds with simple keystrokes. After a few questions, the doctor confirms that the symptoms are classic upper respiratory infection with the possibility of bronchitis. The symptom clusters are found in the ear nose and throat organ system accessed by the code “.SEURIF” which represents “S” for Symptoms. “E” for ear nose and throat and “URIF” which stands for an upper respiratory infection with a fever.” Optionally, the same cluster can be programmed to be accessed by different codes. For example, so long as there is no confusion with another code system the method may be abbreviated to “.SURI.” because the code URI is understood to be part of the ear, nose and throat system.

If the patient complains of all of the symptoms except a sore throat, a cluster can be accessed “.SEURINST” which is the phrase for the symptoms of an upper respiratory infection with no sore throat. A phrase for this may read, “Patient has malaise, head congestion, discharge and cough with fever and no sore throat.”

If the patient complains of all of the symptoms except a sore throat and cough, a cluster or phrase can be accessed “.SEURINSTNC” which documents symptoms of an upper respiratory infection with no sore throat and no cough. A phrase for this may read, “Patient has malaise, head congestion, discharge and no sore throat and cough.”

There are 8 ear nose and throat symptoms that can be included in the diagnosis for an upper respiratory infection. The definitive are malaise, head congestion, discharge, cough and no sore throat. Thus, the template would begin with the initial five core symptoms which can be taken away by adding negative symptom codes, i.e. “NST” for no sore throat or build on the symptoms with the additional three symptoms, e.g. adding “F” after the third keystroke set for “F” for fever. The symptom cluster can be based upon statistical probability that the symptoms will coexist or it can be based upon an actual definition of the diagnosis. But, in clinical practice there must be flexibility to match the list of symptoms with the individual patient and his or her presentation. This is accomplished above by defining a cluster of symptoms that is accessed by an abbreviation code and modifying the abbreviation code with additional symptoms and negative symptoms.

Additional information can be added into the abbreviation code that accesses a particular symptom cluster. Each symptom has a time description, a course of the symptom and severity. The code for recording a symptom is .stime. “S” represents symptom and is the first keystroke set. “Time” or “t” is the second keystroke set and initiates all time descriptors. The third time descriptors may include 1 d, 1 day, 2 d, 2 days, }vv, 1 week, 3 mo, 3 month, 2 y, 2 years, etc. for various course times. A symptom having a duration of one week could have a cluster accessed by “.st 1 w”.

The course codes can all be accessed by phrases like worsening, stable, improving, etc and these are saved as .scourse and shortened to .sc. For example, a phrase for an improving symptom could be accessed by .scim. “S” is the first keystroke set for symptom, “c” or “course” are optionally the second keystroke set representing course group of phrases. “imp”, “wor” or “sta” are optional third keystroke sets for “improving,” “worsening” or “stable,” respectively.

The second keystroke “c” can represent both “cardiovascular” or “course” without confusion by choosing third keystroke sets that distinguish between the possible cardiovascular symptoms and the course definitions. For example, the third keystroke set for “worsening” could be “wor” or “worsening” which will not appear to be a cardiovascular symptom.

Severity phrases are also common to all descriptions of complaints can be saved with a second keystroke set of “s” or “severity.” Thus, “.ss” followed by “crit” or “critical, will access a sentence indicating the symptom is “critical.” A string of codes, .seurif .st5d, scwor” .ssmod” will cause the printout of a paragraph explaining the patient has an upper respiratory infection with the five basic symptoms of malaise, cough, head congestion, sore throat and runny nose. The patient has a fever. The patient indicates that the infection is moderate. It has lasted for five days. The symptoms are worsening.

Negative review of symptoms for an organ system is important to diagnose. The first keystroke set for a negative review of symptoms is “N.” Once again a cluster can be accessed that describes a group of system which can be modified by adding or taking away specific complaints in the manner similar to the symptom codes. For, example, .nppbronchitis accesses a negative review of symptoms cluster for bronchitis. “N” represents a “negative review of systems” first keystroke set. “P” represents the pulmonary system as a second keystroke set. “Bronchitis” represents a third keystroke set as a symptom or cluster of symptoms. “.npbronchitis” would access a cluster of phrases that would document that bronchitis was considered but ruled out.

Some symptoms or negative symptoms are of such importance that they have a red flag status.” For example in considering a diagnosis for an upper respiratory infection, pneumonia would he an important “red flag” condition to either diagnose or rule out as a negative symptom. A negative red flag symptom code for pneumonia is “.nrfpneumonia.” “N” represents a negative review of systems. “RF” is a second keystroke set representing “red flags.” “Pneumonia” is a third keystroke set for pneumonia. Typing, “.nrfpneumonia” references a phrase that states, “The patient denies symptoms of pneumonia, no SOB, tachypnea, chest pain, etc.”

The entire documentation for an upper respiratory infection can be saved and accessed as a cluster with a complete visit code. For example, “.svuri” can be the most common symptoms for an upper respiratory infection with symptoms and negative review of systems with all of the most likely documentation. Like others codes, the visit codes can be modified. For example, “.svuril weekworsening” represents the five most common observations for a visit relating to an upper respiratory infection and further “. . . would be specific with 1 week of worsening symptoms” and would include the phrases accessed by .nrf if desired by the physician using the system.

The examination documentation is next reviewed. It differs from the symptom review and negative review of systems, because the symptoms and negative review of systems record subjective conditions described by the patient. The examination details the objective observations of the physician, nurse or assisting healthcare worker. As noted above, the nurse may begin with .xv for examination of vital signs. X being the first keystroke set for examination. V being the second keystroke set for vital signs. Specific vital sign phrases can be added with a third keystroke set. A third keystroke set, “standard” or “std” may be programmed to produce a cluster of vital sign codes that are routinely taken with each office visit, such as pulse, temperature, blood pressure and body mass.

Other examination codes refer to appearances and can be accessed by .xap. “AP” being the second keystroke set for observation of appearances. For example, “.xapill” or “.xapdistress” with “ill” or “distressed” as the third keystroke set for appears ill or appears distressed. Each can further be modified as “mild,” “moderate” or “severe.” For example, “.xapdistressmoderate” will reference a phrase that documents that the patient appears moderately distressed during the examination. The code beginning “.xh”, “.xe” “xne”, “xnose,” are a head exam (or head and neck), ear exam, neck exam, and nasopharyngeal exam in that order. Each can be further modified with the third keystroke sets. For example, a cluster can be accessed by typing “.xhuri” would be the common specific head and neck exam for an upper respiratory infection including examination for nasal edema, pharyneal redness and small lymph nodes.

Further modifications can eliminate specific negative symptoms. For example, if there is no nasal edema, “.xhurinnedema” would document the common neck and head symptoms for an upper respiratory infection without nasal edema. If there is exudates in the throat, xhurisexudate would document the most common head and neck symptoms of an upper respiratory infection and include a phrase documenting the observation of exudates in the throat. A common visit code could be programmed for an examination. “.xvuri” would include everything in the examination for a visit relating to an upper respiratory infection including vital signs, appearance, head and neck and pulmonary system.

The diagnosis step is shown as Box D of FIG. 1. Diagnosis can be documented in a similar manner with a first keystroke set of “d” for diagnosis. A second keystroke set documents the system, “e” for ear, nose and throat; the third keystroke set, “uri” accesses a phrase documenting that the diagnosis is an upper respiratory infection. Modifiers as discussed above including red flags, negative red flags and co-morbid conditions can likewise be documented.

The treatment plan relates to Boxes E, F and G of FIG. 1. The treatment plan is documented by the first keystroke set “P.” The second keystroke set includes “follow-up” or “F.” The reference code “.pfworsening” documents a request for a follow-up (Box G) visit if conditions worsen. The reference code, “.pti-f” documents follow-up for various red flag conditions such as pneumonia or dehydration by codes pfi-fpneumonia or pfrfdehydration. Treatment plan can include codes documenting additional testing (Box F), referral to specialist, care instructions (Box E) or other therapeutic options.

A similar system can be used accessing standard instruction or information sheets relating to the treatment plan. For example, “.pi” relates to plan instructions to the patient. A smart text list of plan instructions will begin to list for menu options. For example, .pipneumonia would select a standard list of instructions to the patient for a diagnosis to the patient.

Form letters relevant to the treatment plan can likewise be accessed. The reference code .plpneumonia produces form letters that are relevant to a pneumonia diagnosis, if needed. The reference code, .prpneumonia would include standard prescription options for treatment of a patient. A plan with a treatment goal for a pneumonia diagnosis can be treated with the designation .pgpneumonia.

The complexity of the charting system could be daunting except that the organization of the system is based on organ systems just as the physician's trained logic.

While this invention has been particularly shown and described with references to example embodiments thereof, it will be understood by those skilled in the art that various changes in form and details may be made therein without departing from the scope of the invention encompassed by the appended claims.

What is claimed is:

1. A medical record keeping system for recording medical facts, the system comprising:
a computer having a QWERTY keyboard; and
medical record software configured to maintain patient records, wherein the medical record software uses a multiple keystroke reference code to access and insert into a medical record a specific phrase or cluster of phrases relating to a medical fact, wherein the multiple keystroke reference code comprises:
a first keystroke set configured to access a first group of phrases or clusters of phrases that pertain to at least one of: phrases and clusters of phrases relating to symptoms, phrases and clusters of phrases relating to negative review of systems, phrases and clusters of phrases relating to examination observations, phrases and clusters of phrases relating to medical diagnosis, and phrases and clusters of phrases relating to treatment plans;
a second keystroke set configured to modify the first keystroke set to access a second group of phrases or clusters of phrases within the first group of phrases or clusters of phrases that correspond to a particular organ system or anatomical part identified by the second keystroke set; and
a third keystroke set configured to modify the first and second keystroke sets to access the specific phrase or cluster of phrases within the second group of phrases or clusters of phrases.

2. The system of claim 1, wherein the medical records software includes a smart text system configured to provide a selection of reference code options compatible with keystrokes entered when typing the reference code.

3. The system of claim 1, wherein the medical records software is accessible by a handheld computer, smart phone, or personal digital assistant.

4. The system of claim 1, wherein the software includes an edit feature to edit, delete, or insert reference codes and phrases.

5. A method of using a system for documenting a patient encounter, wherein the system includes a computer having a QWERTY keyboard and medical record software configured to maintain patient records, wherein the medical record software uses a multiple keystroke reference code to access and insert into a medical record a specific phrase or cluster of phrases relating to a medical fact, wherein the multiple keystroke reference code comprises:
a first keystroke set configured to access a first group of phrases or clusters of phrases that pertain to at least one of: phrases and clusters of phrases relating to symptoms, phrases and clusters of phrases relating to negative review of systems, phrases and clusters of phrases relating to examination observations, phrases and clusters of phrases relating to medical diagnosis, and phrases and clusters of phrases relating to treatment plans;
a second keystroke set configured to modify the first keystroke set to access a second group of phrases or clusters of phrases within the first group of phrases or clusters of phrases that correspond to a particular organ system or anatomical part identified by the second keystroke set; and
a third keystroke set configured to modify the first and second keystroke sets to access the specific phrase or cluster of phrases within the second group of phrases or clusters of phrases, the method comprising:
using a first reference code to insert a first specific phrase or cluster of phrases relating to subjective medical observations;
using a second reference code to insert a second specific phrase or cluster of phrases relating to objective medical observations;
inserting a third specific phrase or cluster of phrases relating to a medical diagnosis; and
inserting a fourth specific phrase or cluster of phrases relating to a treatment plan.

6. The method of claim 5, wherein inserting a third specific phrase further comprises inserting a third specific phrase or cluster of phrases using a third reference code.

7. The method of claim 5, wherein inserting a fourth specific phrase further comprises inserting a fourth specific phrase or cluster of phrases using a fourth reference code.

8. The method of claim 5, wherein the method is performed by remote access from a handheld computer device.

9. The method of claim 5, wherein the first phrase or cluster of phrases functions as a checklist during patient evaluation or examination.

10. The method of claim 5, wherein the second phrase or cluster of phrases functions as a checklist during patient evaluation or examination.

11. The method of claim 5, wherein the third phrase or cluster of phrases functions as a checklist during diagnosis or formulation of a treatment plan.

12. The method of claim 5, wherein the fourth phrase or cluster of phrases function as a checklist during diagnosis or formulation of a treatment plan.

13. A computer readable medium defining a first keystroke set configured to access a first group of phrases or clusters of phrases that pertain to at least one of: phrases and clusters of phrases relating to symptoms, phrases and clusters of phrases relating to negative review of systems, phrases and clusters of phrases relating to examination observations, phrases and clusters of phrases relating to medical diagnosis, and phrases and clusters of phrases relating to treatment plans;
a second keystroke set configured to modify the first keystroke set to access a second group of phrases or clusters of phrases within the first group of phrases or clusters of phrases that correspond to a particular organ system or anatomical part identified by the second keystroke set; and
a third keystroke set configured to modify the first and second keystroke sets to access the specific phrase or cluster of phrases within the second group of phrases or clusters of phrases,
the computer readable medium including program instructions which when executed by a processor cause the processor to:
accept a first reference code to insert a first specific phrase or cluster of phrases relating to subjective medical observations;
accept a second reference code to insert a second specific phrase or cluster of phrases relating to objective medical observations;
accept a third specific phrase or cluster of phrases relating to a medical diagnosis; and
accept a fourth specific phrase or cluster of phrases relating to a treatment plan.
